(19) United States
(12) Patent Application Publication
(10) Pub. No.: US 2007/0025686 A1
(43) Pub. Date: Feb. 1, 2007

(54) Video autograph and associated methods

(76) Inventor: Todd Richard Shorthouse, Altamonte Springs, FL (US)

Correspondence Address: TODD R. SHORTHOUSE, 543-202 VIA FONTANA LANE, ALTAMONTE SPRINGS, FL, 32714, US

(21) Appl. No.: 11/487,124

(22) Filed: Jul. 14, 2006

Related U.S. Application Data
(60) Provisional application No. 60/699,350, filed on Jul. 14, 2005.

(51) Int. Cl. H04N 5/93

(52) U.S. Cl. 386/52

(57) ABSTRACT

A combination Apparatus and Personalized Video Dedication product. The Apparatus is defined as a trophy, digital picture frame, sports object, or other three dimensional object that houses a video screen and audio output system. The Personalized Video Dedication is defined as a pre-recorded and/or rendered video that contains a video dedication from a celebrity personality, whether human or fictional, directed towards a specific individual.

### FIELD OF THE INVENTION

This invention relates to multimedia interactive networks and, more specifically, to an apparatus comprising a display screen which shows a recorded and signed video dedication by a celebrity personality, the dedication being directed to a specific customer.

### BACKGROUND

Collecting autographs from celebrities and other personalities has been popular for years. The advent of easily recorded digital videos provides the opportunity to create a new product comprising a personal message from a celebrity to a customer, the message preferably including an autograph by the celebrity and one or more visual images. The message, image(s) and autograph capable of being shown through a typical screen display associated with a computer. Moreover, the entire process may be conducted on-line through a global computer network.

### BRIEF DESCRIPTION OF THE DRAWINGS

Some of the features, advantages, and benefits of the present invention having been stated, others will become apparent as the description proceeds when taken in conjunction with the accompanying drawings, presented solely for exemplary purposes and not with intent to limit the invention thereto, and in which:

FIG. 1 is an apparatus according to an embodiment of the present invention.

### DETAILED DESCRIPTION

The present invention will now be described more fully hereinafter, in which description preferred embodiments of the invention are discussed. Unless otherwise defined, technical and scientific terms used herein have the same meaning as commonly understood by one of ordinary skill in the art to which this invention pertains. Although methods and materials similar or equivalent to those described herein can be used in the practice or testing of the present invention, suitable methods and materials are described below. In addition, the materials, methods and examples given are illustrative in nature only and not intended to be limiting. Accordingly, this invention may be embodied in many different forms and should not be construed as limited to the illustrated embodiments set forth herein. Rather, these illustrated embodiments are provided solely for exemplary purposes so that this disclosure will be thorough and complete, and will fully convey the scope of the invention to those skilled in the art. Other features and advantages of the invention will be apparent from the following detailed description, and from the claims.

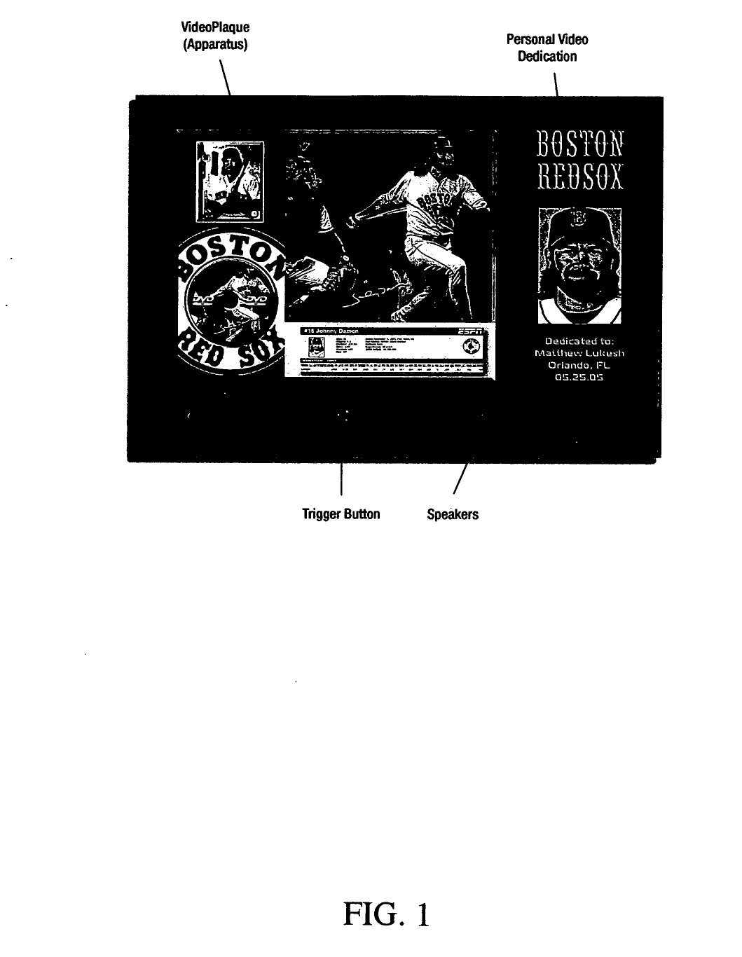

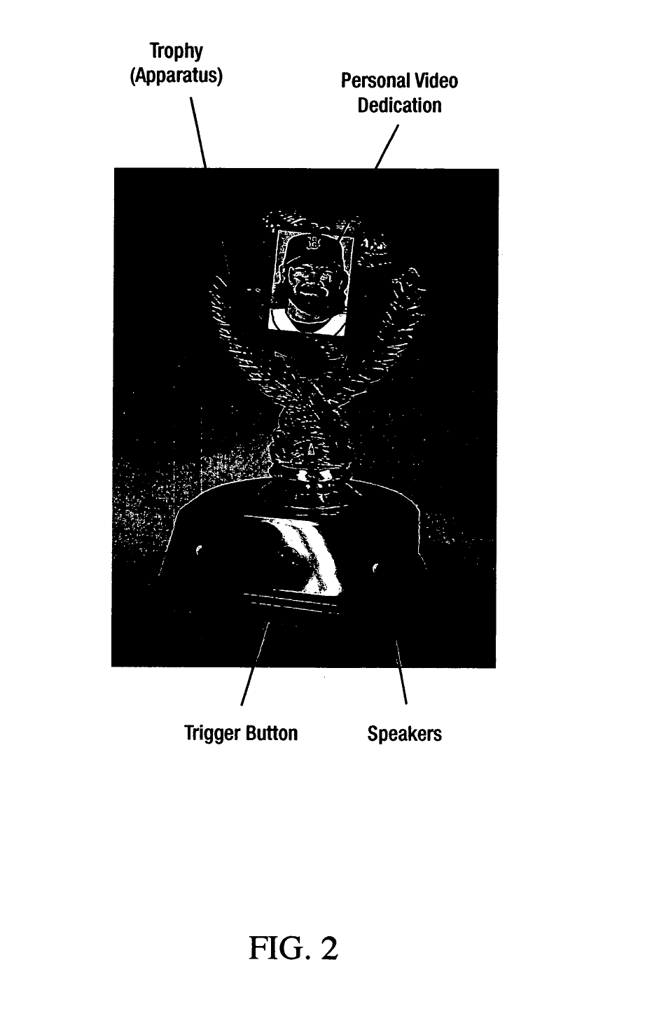

FIG. 1 provides a non-limiting example of an embodiment of the present invention. The illustration shows the autograph product of the invention. A method of the invention includes a plurality of contractual agreements whereby celebrities, sports figures, inspirational leaders and other personalities of public interest will join to participate in the video autograph system to provide personalized, autographed messages for customers.

As shown in FIG. 1, components of the system of the invention include a photo or a photo montage of the personality providing the autograph, a plaque, career and/or history highlights, and a computer disk, preferably a DVD. The DVD will feature one or more videos of the personality and other pertinent visuals related to each icon represented, as well as the personality's autographed dedication. This will be produced by each personality and will include a short, perhaps 5-second video dedicated to the individual customer.

For example, the illustration of FIG. 1 shows Boston Red Sox baseball player Johnny Damon and a superimposed video slot with a dedication to Matthew Lukesh of Orlando, Fla. The image is a pop-up video that will play when the DVD is inserted into an associated computer or applicable player and has Mr. Damon making a live video dedication specifically to the customer Matthew Lukesh. It should be understood that the celebrity is able to make the dedication video from the comfort of his/her own home or office—effectively providing celebrities with a new source of income, and providing customers with the opportunity to obtain a once-in-a-lifetime personal video autograph from his favorite baseball player.

It should also be understood, however, that the presently described invention is applicable for use not only with celebrity dedications, but is also amenable for use by ordinary people and even fictional characters as the entity making the personalized dedication or other personal expression directed at a specific recipient, perhaps a loved one, a parent, son or daughter, and the like. The invention would preferably include the celebrity/personality audibly speaking the recipient's name as part of the dedication.

The making of a live video dedication will not take much longer than the typical handwritten personalized dedication and signature and will provide an audiovisual snapshot of a living legend, celebrity, or loved one, that will be cherished for generations to come.

Those skilled in the art will readily understand that the present invention includes a method of doing business in which celebrities agree to participate in the video autograph system for a predetermined fee per autograph. Available personalities may listed through an on-line catalog and interested customers are then able to purchase a desired video autograph by ordering on-line. The on-line customer order may include a comment by the customer directed to the celebrity whose video autograph is being purchased. The celebrity may then tailor his/her dedication according to the customer's comments. Such a system may be implemented through existing global computer networks and may be accessed by anyone having computer access thereto.

Additionally, the invention contemplates that all celebrities participating in the system will have access to a directory listing all other participating celebrities and personalities, thereby having the opportunity themselves to directly interact with each other on-line, if they so wish. The present system provides for a participating personality/celebrity to receive a computer system with full audiovisual recording capabilities as part of the agreement and to ensure that all participants are using compatible equipment. Further, this invention is quite capable of being implemented with a laptop computer and a video camera, adding the advantages of mobility and ease of use for each participating celebrity/personality.

A further use of the present invention includes political fund raising. Supporters of a particular political party or candidate could obtain a personalized DVD dedication from the candidate for a specified political contribution. The DVD could also include the candidate's discussion of his/her views on various campaign issues, as well as rebuttals of the opposing views. In short, the system would provide for a paid political advertisement, personalized to the individual supporter.

In the specification there have been disclosed typical preferred embodiments of the invention, and although specific terms are employed, the terms are used in a descriptive sense only and not for purposes of limitation. The invention has been described in some detail, but it will be apparent that various modifications and changes can be made within the spirit and scope of the invention as described in the foregoing specification and as defined in the appended claims.

What is claimed is:

1. An Apparatus containing a video screen and audio system that features a personalized video dedication from a celebrity personality directed specifically towards an individual.
